(19) United States
(12) Patent Application Publication
(10) Pub. No.: US 2014/0284268 A1
(43) Pub. Date: Sep. 25, 2014

(54) Filter Element of a Fuel Filter and Method for Producing such a Filter Element

(71) Applicant: MANN+HUMMEL GMBH, Ludwigsburg (DE)

(72) Inventor: Daniel Volkmer, Hemmingen (DE)

(21) Appl. No.: 14/299,826

(22) Filed: Jun. 9, 2014

Related U.S. Application Data
(63) Continuation of application No. PCT/EP2012/074664, filed on Dec. 6, 2012.

(30) Foreign Application Priority Data
Dec. 9, 2011 (DE) 10 2011 120 638.1

(51) Int. Cl. B01D 29/13; B01D 29/00

(52) U.S. Cl. CPC B01D 29/13; B01D 29/0093
USPC 210/493.2; 210/497.01; 29/428

(57) ABSTRACT

A filter element of a fuel filter for fuel has a filter medium of a tubular shape. An end member is seal-tightly connected to an end face of the filter medium. A support tube is arranged coaxial to the filter medium and has an end connected to the end member, wherein the support tube has a circumferential wall provided with passages allow fuel to pass through the support tube. A coalescing medium for coalescing water contained in the fuel is provided. A section of the coalescing medium is seal-tightly embedded in the end member. The section of the coalescing medium is supported by the filter medium and the support tube for shape stabilization of the coalescing member.

### CROSS-REFERENCE TO RELATED APPLICATIONS

This application is a continuation application of international application No. PCT/EP2012/074664 having an international filing date of 6 Dec. 2012 and designating the United States, the international application claiming a priority date of 9 Dec. 2011, based on prior filed German patent application No. 10 2011 120 638.1, the entire contents of the aforesaid international application and the aforesaid German patent application being incorporated herein by reference.

### BACKGROUND OF THE INVENTION

The invention concerns a filter element of a fuel filter for fuel, in particular diesel fuel, of an internal combustion engine, in particular of a motor vehicle, comprising at least one filter medium of a tubular design that at least at one end face is connected seal-tightly with an end member, comprising at least one support tube coaxial to the filter medium that at one end is connected to the end member and whose circumferential wall has passages for the fuel, and comprising a coalescing medium for coalescing water contained in the fuel.

Moreover, the invention concerns a method for producing a filter element of a fuel filter for fuel, in particular diesel fuel, of an internal combustion engine, in particular of a motor vehicle, wherein at least one coalescing medium for coalescing water contained in the fuel, a filter medium of tubular design, and a support tube whose circumferential wall has passages for the fuel, are coaxially arranged and connected at least at one end face to an end member.

DE 10 2008 026 485 A1 discloses a multi-layer filter that has an outer media layer, a central media layer, and an inner media layer for filtration of a fluid, for example, fuel, and that is suitable in particular for removal of contaminant materials such as water from fuel. The outer media layer is designed such that free water is initially filtered when fluid passes from the exterior into the filter. The free water does not penetrate through the outer media layer and remains substantially outside of the filter. The central media layer is designed to coalesce the major portion of the emulsified water and to separate the thus coalesced water from the fuel. The water that is heavier than fuel collects at the bottom of the filter and drains through suitable passages at the lower end plate. Up to the point in time when the fuel contacts the inner media layer, most of the water has already been separated and the inner media layer performs a last filtration before the fuel enters a central tube. The central tube that is enclosed within the filter is a perforated D-shaped tube for receiving the filtered fuel. Between the inner media layer and the central media layer, there is an inner media holder for safely holding the media layers as well as for shaping the media layers. Ends of the inner media holder that are facing each other form two large holding loops which, in the area of a flat part of the D-shaped central tube, leave a relatively large space between the inner media layer and the central media layer. At a first end of the filter a lower end plate and at a second end of the filter an upper end plate are provided. The lower end plate comprises a D-shaped central tube projection with a web for arrangement of the D-shaped central tube. The lower end plate comprises also an area in which the ends of the media layers can be fused.

The invention has the object to design a filter element and a method for producing a filter element such that the filter element is reliable, efficient, and robust, is compact and of simple configuration, and can be produced as simply as possible.

### SUMMARY OF THE INVENTION

This object is solved according to the invention in that at least one section of the coalescing medium that is seal-tightly embedded in the end member is supported by means of the filter medium as well as by means of the support tube for shape stabilization.

According to the invention, the filter element is thus realized in a sandwich construction of sorts. In this context, the coalescing medium is embedded between the filter medium and the support tube. The coalescing medium can advantageously be comprised of at least one layer of at least one flexible material that is embedded shape-stably between the filter element and the support tube and is connected at least at one end face seal-tightly with the end member. With flexible materials, coalescing media can be realized which are optimized with regard to their coalescing efficiency and/or their flow-through property. Flexible materials can be matched simply to different mounting spaces, even during final assembly. Flexible means in this context that the inherent shape stability and/or inherent stiffness of the coalescing medium is not sufficient to ensure that the coalescing medium will not bend or buckle when being connected alone, i.e., without assistance by the sandwich configuration according to the invention, with the end member, in particular by pressing into an appropriate soft connecting medium to be cured later on, in particular adhesive or melted surface material of the end member, so that the stability and/or the seal-tightness of the connection may be impaired. The support tube and the filter medium ensure in this context the shape stability of the entire composite. In this way, it is possible to also connect the coalescing medium with its rim to the end member.

The coalescing medium can advantageously be comprised of several layers of a single flexible material or different flexible materials which are connected with each other but can also be loosely placed on each other. A fixed connection between the layers of the coalescing medium, with the filter medium or with the support tube is not required due to the stable embedding between the filter medium and the support tube. The coalescing medium and the filter medium can be manufactured from different materials. The coalescing medium and the filter medium can be produced separately from each other. It is not required that the coalescing medium is folded or shape-stabilized in any other form by shaping. In this way, the coalescing medium and thus also the entire filter element can be of a compact configuration.

The end member is advantageously an end disk. However, also end members of a different kind can be provided. The filter medium serves for removing particles from the fuel. The filter medium can be shape-stable by shaping and/or material selection. It can be a folded filter medium, in particular a nonwoven. Also, a voluminous filter medium, in particular a filter foam, can be employed. Tubular in the meaning of the invention means that in particular a cylindrical or cubic hollow member is concerned. The hollow member can have in particular a round, oval or angular basic surface.

In an advantageous embodiment, the coalescing medium can be of a fluffy material, in particular a material with a weight per surface area of less than approximately 400 g/m² per 1 mm thickness, preferably greater than approximately 50 g/m² per 1 mm thickness. Also, with a fluffy material the ratio of coalescing efficiency to the required material volume can be further improved. Fluffy material can be arranged in a simple way between the filter medium and the support tube. Moreover, layers of fluffy material can be realized in a simple way.

Advantageously, the coalescing medium can have a thickness between approximately 0.5 mm, preferably approximately 1 mm, and approximately 20 mm. In this way, an optimal coalescing action with pressure loss as little as possible can be achieved.

Advantageously, the filter medium, the support tube, and the coalescing medium can be connected by means of an adhesive connection, a weld connections or a fused connection with the at least one end member, in particular can be pressed with their respective end faces into an adhesive or into a surface of the end member that is soft for mounting, in particular melted, and hardens later on. By means of adhesive connections, weld connections, and fusing connections, stable and at the same time seal-tight connections can be realized in a simple way. Embedding of the coalescing medium between the filter medium and the support tube ensures in this context that the coalescing medium is immersed with closed circumference at the end face rim into the adhesive or the soft surface of the end member and in this way is connected seal-tightly with the end member.

Advantageously, the inherent mechanical stability of the coalescing medium can be smaller or approximately identical to the mechanical stability of the soft adhesive or to the surface of the end member that is soft for assembly. Such soft coalescing material can be processed and shaped easily. It can be flowed through with minimal pressure loss. The soft coalescing medium can moreover be optimally penetrated by the soft adhesive or the soft surface of the end member. In this way, a stable and seal-tight connection between coalescing medium and the end member can be realized.

Advantageously, the coalescing medium can be comprised of viscose or polypropylene or polybutylene terephthalate. These materials can be produced easily. With them, an optimal coalescing action with minimal pressure loss can be achieved.

Advantageously, at least the section of the coalescing medium that is seal-tightly embedded in the end member can be supported immediately on the filter medium. The intermediate layer of separate support elements is not required. The stability of the sandwich structure can be improved in this way.

Advantageously, at least the section of the coalescing medium that is seal-tightly embedded in the end member can be supported immediately on the support tube. The intermediate layer of separate support elements is not required. The stability of the sandwich structure can be additionally improved in this way.

Moreover, advantageously the filter medium, the support tube, and the coalescing medium can be connected at both end faces with an end member, respectively. In this way, the filter medium, the support tube, and the coalescing medium can be seal-tightly arranged between the two end members. One of the end members can serve as a connecting part provided with appropriate passages for the fuel; the other end member can have passages for the separated water.

The coalescing medium can advantageously have at least one layer of a flat material. Flat material can be simply arranged coaxially relative to the support tube and to the filter medium. It is spaced-saving and compact. A uniform material thickness can be achieved with flat material.

Also, advantageously the filter medium can be folded in a zigzag shape. Due to the zigzag-shaped folding a good shape stability can be achieved. An optimal ratio between the required mounting space of the filter medium and the active surface area for filtration can be achieved by zigzag-shaped folding.

Advantageously, a flow direction of the fuel through the filter medium can be extending from the exterior to the interior in radial direction and the support tube can be located in an interior of the filter medium, or the flow direction of the fuel through the filter medium can be from the interior to the exterior in radial direction and the support tube can surround the filter medium on the radial outer side. When the filter medium is configured to be flowed through from the exterior to the interior in radial direction and the support tube is located in the interior of the filter medium, in particular a separating unit for separating the combined water drops can be arranged additionally in the interior in a space-saving way. Alternatively, the filter medium can be flowed through also from the interior to the exterior in radial direction; in this case the support tube is arranged on the radial outer side and surrounds the filter medium and the coalescing medium.

In a further advantageous embodiment, the filter element can be arranged exchangeably in a housing of a fuel filter. The filter element can thus be simply replaced, as needed, in particular for servicing purposes, without the entire fuel filter having to be exchanged. In this way, the need for replacement parts over the service life of the fuel filter can be reduced. The housing and the other components of the fuel filter can be designed as lifetime components.

Advantageously, the filter element can be a round filter element. A round filter element can be of a compact design. It can have an optimal ratio of the active surface for filtration and coalescence to the required mounting space.

Moreover, the technical object is solved according to the invention in regard to the method in that at least one section of the coalescing medium is supported by means of the filter medium as well as by means of the support tube for shape stabilization and is seal-tightly embedded at the end member. According to the invention, the coalescing medium of at least one layer of at least one flexible material is shape-stably embedded between the filter medium and the support tube and, subsequently, the filter medium, the support tube, and the coalescing medium together are seal-tightly connected at the at least one end face with the end member. The advantages and features described in connection with the filter element according to the invention apply likewise to the method according to the invention for producing a filter element and its advantageous embodiments.

### BRIEF DESCRIPTION OF THE DRAWINGS

Further advantages, features, and details of the invention result from the following description in which an embodiment of the invention will be explained in more detail with the aid of the drawing. A person of skill in the art will consider the features disclosed in combination in the drawing, the description, and the claims also expediently individually and combine them to other meaningful combinations.

FIG. 1 shows a longitudinal section of a fuel filter with a coalescing medium which is embedded between a filter medium and a support tube.

In the FIGURE same components are provided with same reference characters.

### DESCRIPTION OF PREFERRED EMBODIMENTS

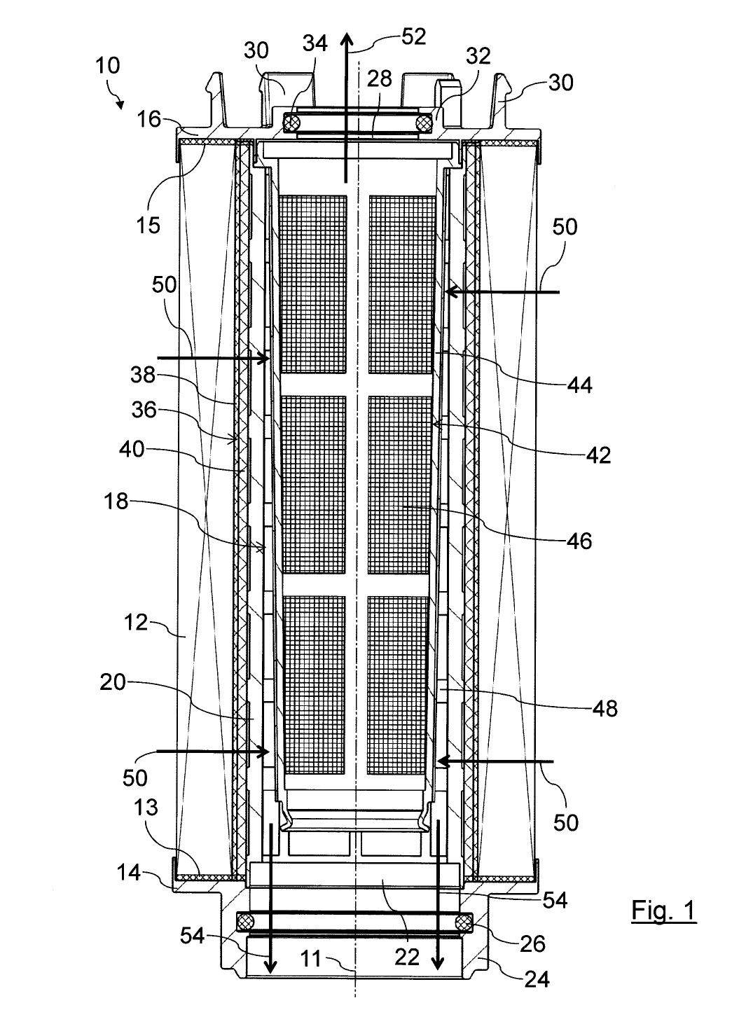

In FIG. 1, an exchangeable filter element 10 of a fuel filter, not shown otherwise, of a fuel system of an internal combustion engine of a motor vehicle is illustrated in longitudinal section. The filter element 10 serves for purifying the fuel employed for operation of the internal combustion engine, for example, diesel fuel. Moreover, the filter element 10 serves for separating water contained in the fuel.

The filter element 10 is arranged in an openable housing of the fuel filter. The filter element 10 is designed as a round filter element. The filter element 10 separates in the mounted state a fuel inlet of the housing seal-tightly from a fuel outlet. In the normal mounted position under normal operating conditions of the internal combustion engine, the filter axis 11, as indicated in FIG. 1, is oriented spatially in vertical direction. “Axial”, “radial”, “coaxial”, and “circumferential” refer in the following to the filter axis 11, if nothing different is indicated.

The filter element 10 comprises a zigzag-shaped folded star-shaped filter medium 12 with which in particular particles are filtered out of the fuel to be purified. The filter medium 12 has as a whole the shape of a coaxial circular cylinder wall. On an end face at the bottom in FIG. 1, the filter medium 12 is seal-tightly connected by means of an adhesive layer 13 with a terminating end disk 14. At its opposite upper end face, the filter medium 12 is connected with an adhesive layer 15 seal-tightly with a connecting end disk 16.

Between the connecting end disk 16 and the terminating end disk 14, a skeletal fluid-permeable central tube 20 which serves as a support tube is extending coaxially in an interior 18 of the filter medium 12. The central tube 20 is also stably connected by means of the adhesive layers 13 and 15 with the end disks 14 and 16, respectively.

The terminating end disk 14 has a coaxial water drainage opening 22. The central tube 20 is inserted in the water drainage opening 22. The water drainage opening 22 connects the interior 18 with a water outlet of the housing. On the exterior side which is facing away from the central tube 20 the terminating end disk 14 comprises a coaxial receiving socket 24 for an appropriate insertion socket of the housing. At its radial inner circumferential wall, the receiving socket 24 has a sealing groove with an annular seal 26.

The connecting end disk 16 has a coaxial fuel outlet opening 28. The fuel outlet opening 28 is surrounded by several locking noses 30, not of interest in this context, which extend on the exterior side of the connecting end disk 16 in axial direction. The locking noses 30 serve inter alia for fixation of the filter element 10 in the housing. Also, the connecting end disk 16 has at its exterior side an outlet receiving socket 32 for an appropriate outlet-side insertion socket of the housing. At its radial inner circumferential side, the outlet receiving socket 32 has a sealing groove with an annular seal 34.

Between the radial inner circumferential side of the filter medium 12 and the central tube 20 a coaxial coalescing medium 36 is embedded sandwich-like. The coalescing medium 36 is immediately supported on the radial inner circumferential side of the filter medium 12 and on the radial outer circumferential side of the central tube 20. The coalescing medium 36 is comprised of two layers 38 and 40 of a flexible fluffy coalescing material. The coalescing medium (36) is made of viscose. It can also be comprised of a different material, for example, polypropylene (PP) or polybutylene terephthalate (PBT). The coalescing material has a weight per surface area smaller than approximately 400 g/m² per 1 mm thickness, preferably greater than approximately 50 g/m² per 1 mm thickness. The coalescing medium 36 has a radial thickness between approximately 0.5 mm, preferably approximately 1 mm, and approximately 20 mm. In other applications the coalescing medium can also have a thickness of greater than 20 mm. The coalescing medium 36 is circumferentially closed and extends between the connecting end disk 16 and the terminating end disk 14. At its end faces, it is connected by means of the respective adhesive layer 13 and 15 seal-tightly with the corresponding end disks 14 and 16. The coalescing medium 36 serves for combining even smallest water droplets contained in the fuel to larger water drops.

In the interior which is delimited by the central tube 20 and the coalescing medium 36, i.e., also in the interior 18 of the filter medium 12, a separating unit 42 is arranged. The separating unit 42 serves for removing the water droplets from the fuel. The separating unit 42 comprises a support cage 44 and a separating medium 46.

The separating medium 46 is comprised of a hydrophobic screen fabric. It has the shape of a conical tube that is coaxial to the filter medium 12. It extends from the connecting end disk 16 almost up to the terminating end disk 14. The separating medium 46 is circumferentially closed.

The circumferential wall of the support cage 44 is of a grid-like construction and liquid-permeable. The support cage 44 is opened in the direction toward the fuel outlet opening 28. The lower end face of the support cage 44 which is facing the water drainage opening 22 is closed. The separating medium 46 is positioned at the radial outer circumferential side of the support cage 44.

Between the separating medium 46 and the central tube 20, a precipitation gap 48 is provided in the interior 18. The precipitation gap 48 has the shape of an annular chamber. The precipitation gap 48 is delimited in radial outward direction by the coalescing medium 36 and in radial inward direction by the separating medium 46.

Upon operation of the fuel filter, the fuel to be purified is supplied from a fuel supply line of the fuel system through the fuel inlet into an inlet chamber of the housing. The inlet chamber surrounds the filter medium 12 in radial direction outwardly.

The fuel flows through the filter medium 12, indicated by arrows 50, from its raw side at the radial outer side to the clean side at the radial inner side. In doing so, the fuel is purified by removing particles. The filter medium 12 forms a first stage of the, in total, three-stage filter element 10 for purification/water separation.

At the clean side, the particle-free fuel passes through the layers 38 and 40 of the coalescing medium 36 from the exterior to the interior in radial direction. In doing so, even smallest water droplets contained in the fuel are caught and combined to larger water drops. The coalescing medium 36 forms a second stage for purification/water separation.

The fuel and the large water drops pass through the openings of the central tube 20 and reach the precipitation gap 48.

The fuel flows through the separating medium 46, which is a third stage for purification/water separation, from the exterior to the interior in radial direction and passes upwardly to the fuel outlet opening 28. The purified fuel from which water has been removed exits the fuel filter through the fuel outlet of the housing, indicated by arrow 52, and is supplied to a fuel line of the fuel system.

The large water drops, on the other hand, are retained by the separating medium 46. They sink in the precipitation gap 48 due to their specific weight that is greater in comparison to fuel in downward direction, indicated by arrows 54, to the water outlet of the housing. Through the latter, the water is drained from the fuel filter in a way not of interest in this context.

For producing the filter element 10, the connecting end disk 16, the terminating end disk 14, and the central tube 20 are manufactured separately from plastic material. The separating unit 42 is connected with the connecting end disk 16.

The filter medium 12 is folded in a zigzag shape from a filter nonwoven. The filter medium 12 is arranged with interposition of the two layers 38 and 40 of the coalescing medium 36 on the central tube 20 in a coaxial arrangement. In this context, the coalescing medium 36 is embedded in radial direction shape-stably between the filter medium 12 and the central tube 28 so that a sandwich-like component is formed.

The connecting end disk 16 is provided with the adhesive layer 15. The connecting end disk 16 is mounted, with the separating unit 42 leading, at an end face of the sandwich-like component wherein the separating unit 42 is inserted into the interior 18. The end face rims of the filter medium 12, of the coalescing medium 36, and of the central tube 20 when pressed onto the connecting end disk 16 are seal-tightly pressed into the adhesive layer 15. After hardening of the adhesive layer 15, a stable and seal-tight connection between the connecting end disk 14 and the end face rims of the filter medium 12, the central tube 20, and the coalescing medium 36 is provided.

The terminating end disk 14 is provided with the adhesive layer 13 and is pressed onto the other end face of the sandwich-like component. In doing so, the end of the central tube 20 is inserted into the water drainage opening 22 of the terminating end disk 14. The central tube 20 bonds with the adhesive layer 13 which extends to the radial inner rim of the water drainage opening 22. The coalescing medium 36 is forced at the end face together with the central tube 20 and the filter medium 12 into the adhesive layer 13. After hardening of the adhesive layer 13, a stable and seal-tight connection is formed in this way.

The inherent mechanical stability of the coalescing medium 36 is smaller or approximately identical to the mechanical stability of the soft adhesive layers 13 and 15. Only the sandwich-like support action of the filter medium 12 and of the central tube 20 enable pressing in the coalescing medium 36 into the soft adhesive layers 13 and 15.

The shape-stable sandwich-like embedding of the coalescing medium 36 between the filter medium 12 and the central tube 20 prevents that the coalescing medium 36, which by itself is flexible, buckles or bends at the rim when pressing the end face rims into the adhesive layers 13 and 15. In this way, the end face rims of the coalescing medium 36 can also be pressed strongly into the adhesive layer 13 and 15 so that seal-tight and stable connections are produced.

In the afore described embodiments of a filter element 10 inter alia the following modifications are possible.

The invention is not limited to a filter element 10 of an internal combustion engine of a motor vehicle. Instead it can be used also in different types of internal combustion engines, for example, in industrial motors.

The filter element 10 can also be used for purification/water separation of other types of liquid fuel than for diesel fuel. When a fuel is used whose specific weight is greater than that of water, the water drops will rise. In this case, the filter element 10 can be arranged upside down. The fuel inlet, the fuel outlet, and the water outlet of the housing of the fuel filter can be appropriately arranged also.

The filter medium 12, instead of being folded in a star shape, can also be realized as a hollow member of a different kind, for example, also non-folded or as voluminous filter foam.

The filter medium 12, the coalescing medium 30, and/or the central tube 28, instead of being a hollow cylinder, can also be realized in a different shape, for example, a hollow cone. Instead of round basic surfaces, they can have also different kinds of basic surfaces, for example, oval or angular.

The filter element 10, instead of being exchangeable, can also be mounted fixedly in an appropriate housing.

The end faces of the filter medium 12, of the coalescing medium 36, and of the central tube 20 can also be connected in a different way seal-tightly with the end disks 14 and 16 instead of by means of adhesive layers 13 and 15. For example, the end faces can also be connected by means of a melt connection in which the appropriate surfaces of the end disks 14, 16 are first melted or softened in other ways so that the end face of the sandwich-like component can be pressed into the soft end disk 14 or 16. After hardening of the surfaces, the seal-tight and stable connections are formed.

The coalescing medium 36 can also be provided with fewer or more than two layers of flexible coalescing material.

Instead of being made of the same coalescing material, the layers 38 and 40 of the coalescing medium 36 can also be comprised of different coalescing materials. Instead of fluffy materials, also different types of flexible, for example, nonwoven-type, coalescing materials can be used.

The filter medium 12, instead of being flowed through in radial direction from the exterior to the interior, can also be flowed through in radial direction from the interior to the exterior by the fuel. Instead of the central tube 20, a different type of support tube can be provided which surrounds the filter medium 12 in radial direction outwardly. The coalescing medium 36 is then embedded radially outside of the filter medium 12 between the filter medium 12 and the support tube.

Instead of the separating unit 42 with the support cage 44 and the separating medium 46, also a different type of separating unit can be provided. Depending on the requirements on the filter element 10 in regard to the separating efficiency for water, the separating unit can also be eliminated.

The connecting end disk 16, the terminating end disk 14, and/or the central tube 20, instead of being made of plastic material, can also be made of a different material, for example, metal.

While specific embodiments of the invention have been shown and described in detail to illustrate the inventive principles, it will be understood that the invention may be embodied otherwise without departing from such principles.

What is claimed is:

1. A filter element of a fuel filter for fuel, the filter element comprising:
a filter medium of a tubular shape;
an end member seal-tightly connected to an end face of the filter medium;
a support tube coaxial to the filter medium and having an end connected to the end member, wherein the support tube has a circumferential wall provided with passages configured to allow fuel to pass through the support tube;
a coalescing medium configured to coalesce water contained in the fuel, wherein a section of the coalescing medium is seal-tightly embedded in the end member;
wherein the section of the coalescing medium is supported by the filter medium and the support tube for shape stabilization of the coalescing member.

2. The filter element according to claim 1, wherein the coalescing medium is comprised of a flexible material.

3. The filter element according to claim 2, wherein the flexible material is a fluffy material.

4. The filter element according to claim 2, wherein the flexible material has a weight per surface area smaller than approximately 400 g/m² per 1 mm thickness.

5. The filter element according to claim 4, wherein the weight per surface area is greater than approximately 50 g/m² per 1 mm thickness.

6. The filter element according to claim 1, wherein the coalescing medium has a thickness between approximately 0.5 mm and approximately 20 mm.

7. The filter element according to claim 6, wherein the thickness of the coalescing medium is between approximately 1 mm and approximately 20 mm.

8. The filter element according to claim 1, wherein the filter medium, the support tube, and the coalescing medium are connected by an adhesive connection, a weld connection or a fused connection with the end member.

9. The filter element according to claim 8, wherein the end face of the filter medium, the end of the support tube, and the section of the coalescing medium are pressed into a soft adhesive provided at the end member to produce the adhesive connection with the end member, or are pressed into a surface of the end member that is softened and later on is hardened to produce the fused connection with the end member.

10. The filter element according to claim 9, wherein an inherent mechanical stability of the coalescing medium is smaller or approximately identical to a mechanical stability of the soft adhesive provided at the end member or of the surface of the end member that is softened for mounting.

11. The filter element according to claim 1, wherein the coalescing medium is made of viscose or polypropylene or polybutylene terephthalate.

12. The filter element according to claim 1, wherein at least the section of the coalescing medium that is seal-tightly embedded in the end member is supported immediately on the filter medium.

13. The filter element according to claim 1, wherein at least the section of the coalescing medium that is seal-tightly embedded in the end member is supported immediately on the support tube.

14. The filter element according to claim 1, wherein two of said end member are provided and the filter medium, the support tube, and the coalescing medium are connected at both ends to one of said end members, respectively.

15. The filter element according to claim 1, wherein the coalescing medium has at least one layer of a flat material.

16. The filter element according to claim 1, wherein the filter medium is folded in a zigzag shape.

17. The filter element according to claim 1, wherein a flow direction of the fuel through the filter medium extends in a radial direction from an exterior to an interior of the filter medium and the support tube is located in the interior of the filter medium.

18. The filter element according to claim 1, wherein a flow direction of the fuel through the filter medium extends in a radial direction from an interior to an exterior of the filter medium and the support tube surrounds the filter medium in the radial direction outwardly.

19. The filter element according to claim 1, configured to be exchangeably arranged in a housing of a fuel filter.

20. The filter element according to claim 1, wherein the filter element is a round filter element.

21. A method for producing a filter element of a fuel filter for fuel, the method comprising:
arranging a coalescing medium for coalescing water contained in the fuel, a filter medium of tubular design, and a support tube having a circumferential wall with passages for the fuel coaxially relative to each in a coaxial arrangement;
connecting at least one end face of the coaxial arrangement with an end member, including:
supporting a section of the coalescing medium with the filter medium and with the support tube for shape stabilization of the coalescing medium;
seal-tightly embedding the section of the coalescing member in the end member.
